(19) United States
(12) Patent Application Publication
(10) Pub. No.: US 2022/0180316 A1
(43) Pub. Date: Jun. 9, 2022

(54) METHOD FOR ESTIMATING ENERGY REQUIRMENTS IN A VEHICLE WITH A VARYING PAYLOAD

(71) Applicant: FORD GLOBAL TECHNOLOGIES, LLC, Dearborn, MI (US)

(72) Inventors: Markus ESPIG, Aachen (DE); David VAN BEBBER, Aachen (DE)

(73) Assignee: FORD GLOBAL TECHNOLOGIES, LLC, Dearborn, MI (US)

(21) Appl. No.: 17/542,669

(22) Filed: Dec. 6, 2021

(30) Foreign Application Priority Data
Dec. 4, 2020 (DE) 102020007413.8

(51) Int. Cl. G06Q 10/08; G06Q 10/06

(52) U.S. Cl. CPC G06Q 10/08355; G06Q 10/06393

(57) ABSTRACT

A method for determining delivery energy requirements includes determining a mass of individual partial loads that make up a total payload and a delivery address of each partial load. The method also includes determining possible delivery routes that cover the delivery addresses and for each possible delivery route, determining an expected traffic volume and initial projected energy requirement for a delivery vehicle, based at least in part on the masses and the delivery addresses of the partial loads, the projected energy requirement reflecting energy projected to complete a given possible delivery route based on the expected traffic volume and based on a decreasing total payload diminished by removing, from the total payload and for at least one partial load, the mass of a given partial load scheduled for delivery at a given delivery stop along the delivery route.

### CROSS-REFERENCE TO RELATED APPLICATIONS

This application claims foreign priority benefits under 35 U.S.C. § 119(a)-(d) to DE Application 10 2020 007 413.8 filed Dec. 4, 2020, which is hereby incorporated by reference in its entirety.

### TECHNICAL FIELD

The illustrative embodiments relate to a method for ascertaining a functional relationship, over time t_{deliver}, of a changing payload m_{add} comprising a multiplicity of singled partial loads i scheduled for delivery, of a delivery vehicle that may include an electric torque source and storage for electrical energy.

### BACKGROUND

In the development of drives for vehicles, efforts are constantly being made to minimize fuel consumption. In addition, attempts are made to reduce pollutant emissions to comply with present and projected future limit values for pollutant emissions.

Electric drives are therefore being used more and more frequently in vehicles, many times in combination with an internal combustion engine, as a hybrid drive. As an emission-free drive, the electric drive provides emission-related benefits in city traffic. Other relevant reasons for the use of electric drives exist as well, for example, the reduction of the drive noise of a vehicle.

When using electric drives, among other things it may be difficult to predict the precise requirement, or consumption, of electrical energy for a forthcoming journey. Ensuring that the electrical energy available in the storage means is sufficient to meet the requirement may be an important prerequisite for planning a journey, especially while recharging and replenishment options remain scarce. A precise prediction of the energy requirement is also useful in order to be able to compare different routes, i.e. travel distances, and to utilize the energy available in the storage means efficiently, or as extensively as possible, before the storage means is replenished.

Different concepts have been used to predict the requirement for electrical energy. The fleet consumption, the average consumption during particular travel cycles, or the consumption of the respective vehicle in the past may be used as a basis to estimate the energy requirement for a forthcoming journey.

The energy requirement for a forthcoming journey may also be estimated computationally by means of simulation models. In that case, vehicle-specific data, for example the mass mᵥₑₕ, the rolling resistance coefficient fᵣₒₗₗ, the drag coefficient c_{w} and/or the area A of the motor vehicle are specified.

Solutions also take into account so-called coasting tests, in which the vehicle coasts on a flat, i.e. non-inclined, test track, starting from a predefinable speed and with the drive train interrupted, the deceleration being acquired by measurement.

Many of the current approaches treat the vehicle-specific data as constants, but those calculations and observations are actually variable and are subject to greater or lesser changes, which is often not taken into account.

For example, the mass m, or payload m_{odd}, of a delivery vehicle can change considerably as it is unloaded and reloaded. This has a significant influence on the energy consumption of the delivery vehicle. The comparatively large change in the mass of a delivery vehicle is often due to the fact that the payload m_{add} of the delivery vehicle is regularly reduced in the course of delivery, i.e. it varies greatly over time t_{deliver}.

### SUMMARY

Against the background of the above, the illustrative embodiments provide a method for ascertaining the payload m_{add} of a delivery vehicle that takes into account that the payload m_{add} of the delivery vehicle changes in the course of delivery.

This may be achieved by a method for ascertaining a functional relationship, over time t_{deliver}, of a changing payload m_{add} comprising a multiplicity of singled partial loads i scheduled for delivery, taking into account one or more of the following parameters:
a mass wᵢ of each individual partial load i,
an expected traffic volume tᵣ,
a delivery address of each individual partial load i.
a deliver rate d, and/or
a delivery route r,
   in which
based on the known masses wᵢ of the partial loads and the delivery addresses of the individual partial loads i, the functional relationship of the payload m_{add} over the time t_{deliver} is ascertained taking into account the delivery route r.

For example, it is taken into account that the payload m_{add} of the delivery vehicle changes in the course of delivery. At the beginning, i.e. before the delivery journey, a forecast is made on the basis of the available data, with the known information relating to the partial loads i, namely the respective weight wᵢ and the respective associated delivery address, being merged with the items of information relating to the delivery route r.

The delivery route r, in turn, regularly depends on the delivery addresses of the individual partial loads i and on the delivery stops that are considered appropriate, and which are an integral part of the delivery route r. The actual delivery route r may be selected from a multiplicity of possible delivery routes, taking into account, for example, the expected traffic volume tr, the masses wᵢ of the individual partial loads i and/or the expected energy requirement, or the electrical energy present and available in the storage means. The delivery route r may also be changed, updated and optimized during delivery. This means that a forecast, or a new more up-to-date forecast, may be made again during the delivery journey.

The weights, i.e. the masses wᵢ of the individual partial loads i to be delivered, are known, and thus also the total payload m_{add,start} at the start of the delivery route r, or at the beginning of the delivery journey. As part of the forecast, the partial loads i scheduled for delivery at each delivery stop are deducted from the payload m_{add} of the delivery vehicle at respective delivery stops. In conjunction with the delivery route, e.g., the delivery distance over time t, the profile of the payload m_{add} of the delivery vehicle over time t is obtained.

This prediction is subject to certain uncertainties, which in particular may result from the fact that it cannot be ensured that the delivery route r and the associated partial routes can be completed as planned and in the scheduled delivery time, and that all partial loads, or packages, can be handed over, i.e. delivered.

In order to optimize or at least improve the prediction, a multiplicity of parameters may in principle be taken into account within the scope of the method according to the invention; for example, the delivery rate d. Other examples are given below.

The delivery rate d takes into account that not all partial loads i scheduled for delivery during a delivery stop are delivered, but remain in the delivery vehicle.

The functional relationship between the payload m_{add} and the time t_{deliver}, i.e. the forecast for the payload m_{add} changing during delivery, is taken into account in the estimation of the electrical energy requirement for the selected, or available, delivery route. The electrical energy requirement may be compared to the electrical energy available in onboard storage.

The method thus takes account of the fact that the energy requirement can vary greatly under different boundary conditions, providing a method for ascertaining the payload m_{add} of a delivery vehicle that takes into account that the payload m_{add} of the delivery vehicle changes in the course of delivery.

Illustrative embodiments of the method include those in which, on the basis of a known payload m_{add,start} at the start of the delivery route r, the mass wᵢ of the at least one partial load i scheduled for delivery at a delivery stop is subtracted from the payload m_{add} of the delivery vehicle, within a prediction, at that delivery stop. These embodiments include methods in which the delivery rate d is taken into account in such a way that not all partial loads i scheduled for delivery at a delivery stop are delivered, and remain in the delivery vehicle. For example, the delivery rate d is set at d≥90%, d≥80%, d≥70%, etc.

Further, the prediction of the payload m_{add} of the delivery vehicle may be updated and retroactively adjusted after a completed delivery stop, taking into account each partial load i actually delivered.

The delivery stop at which the above update is performed may be specified. However, an update may also be performed, for example, after every or every second delivery stop. In addition, highly relevant delivery stops, where many partial loads i are scheduled for delivery, or a comparatively large change in the payload m_{add} is to be expected, may be preselected for an update, allowing for both ongoing load analysis and point-specific load analysis.

Additionally, traffic volume tr may be updated during delivery and taken into account in such a way that the delivery takes more or less time t. Similarly, the delivery route r′ is changed if necessary and taken into account.

Also, the ascertained functional relationship of the payload m_{add} over time t_{deliver} may be used to estimate the electrical energy requirement for a predefinable delivery route. The electrical energy requirement may be compared with the electrical energy available in the onboard storage, and data relating to the state of charge of the energy storage for electrical energy may be managed in an information unit and made available when required.

An accumulator or a capacitor, for example, may serve as onboard energy storage, and it can also absorb and store surplus power, provided by an internal combustion engine, that is not required if the electric machine is not being used as a drive, but as a generator. In this way, energy can also be recovered and stored in an overrun mode.

Energy storage for electrical energy may also be a hydrogen tank in combination with a fuel cell. This combination also provides electrical energy for the electric machine when required and stores electrical energy in the form of available hydrogen.

The illustrative embodiments may also be applied, or transferred, to conventional drives in an equivalent manner. This means, for example, that it may be used in a motor vehicle that has an internal combustion engine as a sole or additional source of torque and that has a fuel tank as fuel storage for fossil energy sources.

The invention is described in more detail in the following with reference to FIGS. 1, 2 and 3.

### BRIEF DESCRIPTION OF THE DRAWINGS

FIG. 1 shows an illustrative functional relationship of the payload m_{add} of the delivery vehicle over time t_{deliver}, according to a first embodiment of the method,

FIG. 2 shows an illustrative functional relationship of the payload m_{add} of the delivery vehicle over time t_{deliver}, according to a second embodiment of the method, and

FIG. 3 shows an illustrative functional relationship of the payload m_{add} of the delivery vehicle over time t_{deliver}, according to a third embodiment of the method.

### DETAILED DESCRIPTION

As required, detailed embodiments are disclosed herein. It is to be understood that the disclosed embodiments are merely representative and may be embodied in various and alternative forms. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ the claimed subject matter and concepts herein.

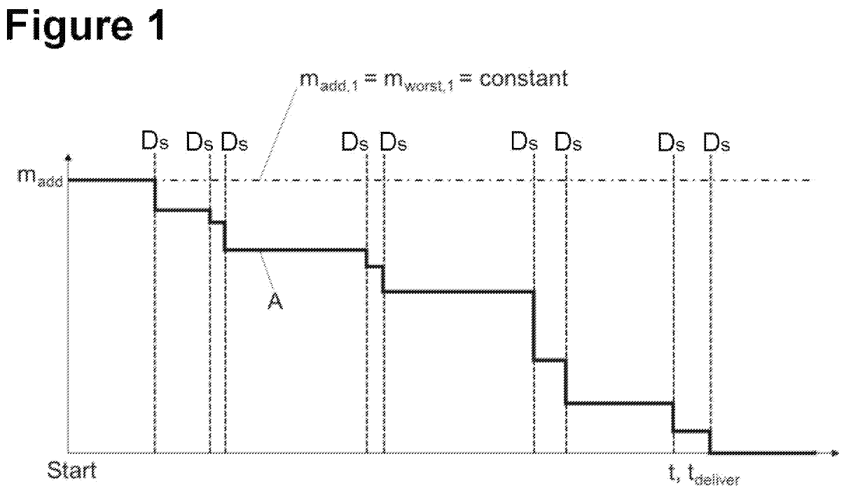

FIG. 1 shows an illustrative functional relationship of the payload m_{add} of the delivery vehicle over time t_{deliver}, according to a first embodiment of the method.

Curve A shows the forecast of the payload m_{add}(t) of the delivery vehicle over time t, according to the first embodiment of the method. The forecast may be created before departure, i.e. before the start of the delivery journey, based on the available data. In this case, the known information relating to the partial loads i, namely the respective weight wᵢ and the respective associated delivery address, may be merged with the information relating to the delivery route r. It is also taken into account that the payload m_{add} of the delivery vehicle changes in the course of delivery.

The masses wᵢ of the individual partial loads i to be delivered are known, and thus also the total payload m_{add,start} at the beginning of the delivery journey. The partial loads i scheduled for delivery at each delivery stop Dₛ are subtracted from the payload m_{add} of the delivery vehicle, within the forecast, at the respective delivery stop Dₛ. In conjunction with the delivery route, i.e. the delivery distance over time t, the profile of the payload m_{add} of the delivery vehicle over time t is obtained.

According to the first embodiment of the method, it is assumed that all partial loads i scheduled for delivery are delivered, i.e. the delivery rate d is set at d=100%. In practice, however, not all partial loads i scheduled for delivery are delivered. Rather, some partial loads i remain in the delivery vehicle, such that a delivery rate d<100% must regularly be assumed.

Indicated by a dash-dotted line in FIG. 1 is a first worst-case scenario, in which the payload m_{worst,1} does not change over the entire delivery, with m_{add,1}=m_{worst,1}=constant. The delivery rate is d₁=0, and all partial loads i remain in the delivery vehicle.

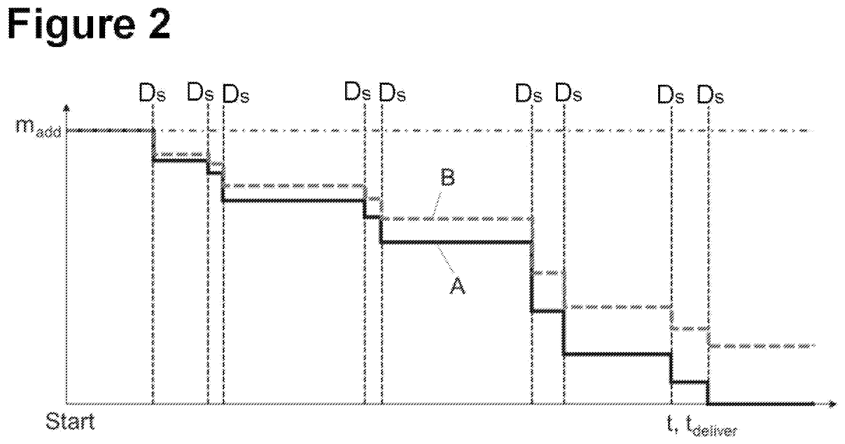

FIG. 2 shows an illustrative functional relationship of the payload m_{add} of the delivery vehicle over the delivery time t_{deliver}, according to a second embodiment of the method, in which a delivery rate d<100% is assumed.

Curve B shows, as a dash-dotted line, the prediction of the payload m_{add}(t) of the delivery vehicle over time t, according to the second embodiment of the method—it already being assumed before the start of the delivery journey that not all partial loads i scheduled for delivery can be delivered.

Curve A shows the forecast of the payload m_{add}(t) of the delivery vehicle over time t, according to the first embodiment of the method, i.e. according to FIG. 1.

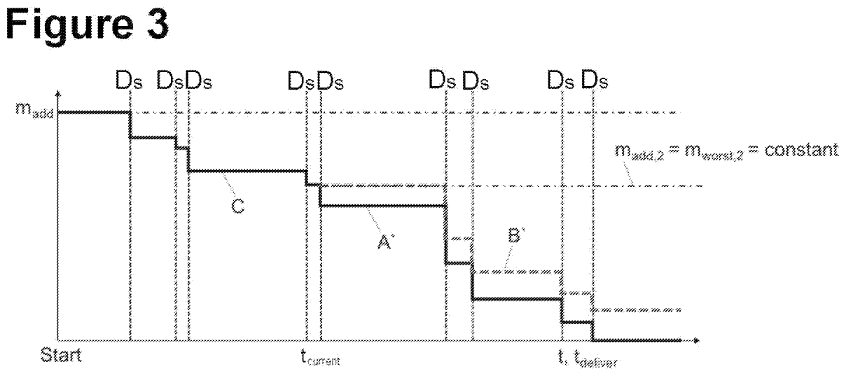

FIG. 3 shows an illustrative example of the functional relationship of the payload m_{add} of the delivery vehicle over the delivery time t_{deliver}, according to a third embodiment of the method.

According to this third method variant, following completion of the fifth completed delivery stop Dₛ, the prediction of the payload m_{add} of the delivery vehicle is updated and retroactively adjusted, taking into account each actually delivered partial load i. Curve C shows the actual payload m_{add}(t) of the delivery vehicle over the elapsed time t.

At the same time, the forecast is updated at the time t=t_{current}, according to one of the process variants represented in FIGS. 1 and 2.

Curve A′ shows the forecast of the payload m_{add}(t) of the delivery vehicle over time t, according to the first embodiment of the method, i.e. with an assumed delivery rate d=100%, before the start of the onward journey.

Curve B′ shows the forecast of the payload m_{add}(t) of the delivery vehicle over time t, according to the second embodiment of the method. i.e. with an assumed delivery rate d<100%, before the start of the onward journey.

Indicated by a dash-dotted line in FIG. 3 is a second worst-case scenario, in which the payload m_{worst,2} does not change over the rest of the delivery, with m_{add,2}=m_{worst,2}=constant. The delivery rate after the fifth delivery stop Dₛ is d₂=0, and all partial loads i not delivered by then remain in the delivery vehicle.

The predictions are subject to a certain degree of uncertainty, which in particular results from the fact that the assumptions made before the start of the delivery journey change during the delivery journey.

In individual cases, the delivery route r and the associated stages may not be completed in the scheduled delivery time because the predicted traffic volume tr does not correspond to the actual traffic volume. The delivery route r may also be changed during delivery. Then a more up-to-date forecast is made during the delivery journey.

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter. Additionally, the features of various implementing embodiments may be combined to form further embodiments that may not be explicitly illustrated or described.

What is claimed is:

1. A method for ascertaining a functional relationship, over a time period, of a changing total payload comprising a plurality of partial loads scheduled for delivery by a delivery vehicle that includes an electric torque source and onboard energy storage, the method comprising:
determining a mass of each individual partial load and a delivery address of each individual partial load;
determining a plurality of possible delivery routes;
for each possible delivery route, determining an expected traffic volume;
for each possible delivery route, determine projected energy requirements for the delivery vehicle, over the time period as the time period changes, based at least in part on a delivery success rate, the known masses of the partial loads and the delivery addresses of the individual partial loads, the projected energy requirements reflecting a decreasing energy requirement over the time period relative to a decreasing load diminished by removing, from the total payload and for at least one partial load, the mass of a given partial load, of the individual partial loads, scheduled for delivery at a given delivery stop along the delivery route; and
selecting a route based at least in part on there being sufficient energy in the onboard energy storage to complete the route r as indicated by the projected energy requirements for the selected route.

2. The method of claim 1, wherein the delivery rate is taken into account in determining the projected energy requirements such that a portion, determined based on the delivery success rate, of the individual partial loads are not removed from the total payload.

3. The method of claim 2, wherein the delivery success rate set at ≥90%.

4. The method of claim 2, wherein the delivery success rate is set at ≥80%.

5. The method of claim 2, wherein the delivery success rate is set at ≥70%.

6. The method of claim 1, wherein the projected energy requirements for a remaining route of the selected route are determined based at least in part on an updated total payload that is updated and actively adjusted after a completed delivery stop, taking into account each partial load actually delivered.

7. The method of claim 6, wherein, if the projected energy requirements of the remaining route indicate greater usage of energy than is stored in the onboard energy storage, the steps of determining the plurality of possible routes, determining the expected traffic volume, and determining the projected energy requirements are repeated to select a new route for the remaining route based at least in part on there being sufficient energy in the onboard energy storage to complete the new route and wherein the repeated determining the projected energy requirements treats the updated total payload as the total payload.

8. A non-transitory computer readable storage medium, storing instructions that, when executed, cause a processor to perform a method for ascertaining a functional relationship, over a time period, of a changing total payload comprising a plurality of partial loads scheduled for delivery by a delivery vehicle that includes an electric torque source and onboard energy storage, the method comprising:
determining a mass of each individual partial load and a delivery address of each individual partial load;
determining a plurality of possible delivery routes;
for each possible delivery route, determining an expected traffic volume;
for each possible delivery route, determine projected energy requirements for the delivery vehicle, over the time period as the time period changes, based at least in part on a delivery success rate, the known masses of the partial loads and the delivery addresses of the individual partial loads, the projected energy requirements reflecting a decreasing energy requirement over the time period relative to a decreasing load diminished by removing, from the total payload and for at least one partial load, the mass of a given partial load, of the individual partial loads, scheduled for delivery at a given delivery stop along the delivery route; and
selecting a route based at least in part on there being sufficient energy in the onboard energy storage to complete the route r as indicated by the projected energy requirements for the selected route.

9. The storage medium of claim 8, wherein the delivery rate is taken into account in determining the projected energy requirements such that a portion, determined based on the delivery success rate, of the individual partial loads are not removed from the total payload.

10. The storage medium of claim 9, wherein the delivery success rate is set at ≥90%.

11. The storage medium of claim 9, wherein the delivery success rate is set at ≥80%.

12. The storage medium of claim 9, wherein the delivery success rate is set at ≥70%.

13. The storage medium of claim 8, wherein the projected energy requirements for a remaining route of the selected route are determined based at least in part on an updated total payload that is updated and actively adjusted after a completed delivery stop, taking into account each partial load actually delivered.

14. The storage medium of claim 13, wherein, if the projected energy requirements of the remaining route indicate greater usage of energy than is stored in the onboard energy storage, the steps of determining the plurality of possible routes, determining the expected traffic volume, and determining the projected energy requirements are repeated to select a new route for the remaining route based at least in part on there being sufficient energy in the onboard energy storage to complete the new route and wherein the repeated determining the projected energy requirements treats the updated total payload as the total payload.

15. A method comprising:
determining a mass of each of a plurality of individual partial loads that make up a total payload and a delivery address of each individual partial load;
determining a plurality of possible delivery routes that cover the delivery addresses of each individual partial load;
for each possible delivery route, determining an expected traffic volume;
for each possible delivery route, determine an initial projected energy requirement for a delivery vehicle, based at least in part on the masses of the partial loads and the delivery addresses of the individual partial loads, the projected energy requirement reflecting energy projected to complete a given possible delivery route based on the expected traffic volume and based on a decreasing total payload diminished by removing, from the total payload and for at least one partial load, the mass of a given partial load, of the individual partial loads, scheduled for delivery at a given delivery stop along the delivery route; and
selecting a route based at least in part on there being sufficient energy in the onboard energy storage to complete the route r as indicated by the projected energy requirement for the selected route.

16. The method of claim 15, wherein a delivery rate is taken into account in determining the projected energy requirement such that a portion, determined based on the delivery rate, of the individual partial loads are not removed from the total payload.

17. The method of claim 15, wherein the projected energy requirement for a remaining route of the selected route is actively determined as the delivery vehicle progresses based at least in part on an updated total payload that is updated and actively adjusted after a completed delivery stop, taking into account each partial load actually delivered.

18. The method of claim 17, wherein, if the projected energy requirement of the remaining route indicate greater usage of energy than is stored in the onboard energy storage, the steps of determining the plurality of possible routes, determining the expected traffic volume, and determining the projected energy requirement are repeated to select a new route for the remaining route based at least in part on there being sufficient energy in the onboard energy storage to complete the new route and wherein the repeated determining the projected energy requirement treats the updated total payload as the total payload.
